(19) United States
(12) Patent Application Publication
(10) Pub. No.: US 2006/0103804 A1
(43) Pub. Date: May 18, 2006

(54) Liquid crystal display device and method of manufacture of the same

(75) Inventor: Jin Hirosawa, Toyama (JP)

Correspondence Address: GREER, BURNS & CRAIN, 300 S WACKER DR, 25TH FLOOR, CHICAGO, IL, 60606, US

(73) Assignee: SHARP KABUSHIKI KAISHA

(21) Appl. No.: 11/251,748

(22) Filed: Oct. 17, 2005

(30) Foreign Application Priority Data
Nov. 12, 2004 (JP) 2004-328431

(51) Int. Cl. C09K 19/02

(52) U.S. Cl. 349/183

(57) ABSTRACT

A liquid crystal composition, comprising a liquid crystal and a polymerizable compound capable of polymerization by means of light, heat, or a combination thereof, is placed in the gap between two parallel substrates on which are formed a pair of electrodes, and the polymerizable compound is polymerized to form a liquid crystal layer and a resin film. A liquid crystal display device is manufactured accordingly. The polymerizable compound comprises a monofunctional polymerizable compound, and the dipole moment of the monofunctional polymerizable compound is 4 debyes or lower. Thus, a liquid crystal display device, with high reliability, and of excellent quality with little or no contrast reduction due to white lines, is provided.

### CROSS-REFERENCE TO RELATED APPLICATIONS

The present application is based upon and claims the benefit of priority from the prior Japanese Patent Application No. 2004-328431, filed on Nov. 12, 2004, the entire contents of which are incorporated herein by reference.

### BACKGROUND OF THE INVENTION

1. Field of the Invention

The present invention relates to a liquid crystal display device and to a manufacturing method for a liquid crystal display device. In particular, the present invention relates to a liquid crystal display device and manufacturing method thereof which utilize a state in which liquid crystal molecules are aligned vertically when no voltage is applied.

2. Description of the Related Art

Conventionally, TN mode liquid crystal display devices, in which a liquid crystal material having a positive dielectric anisotropy is aligned parallel to the substrate surface, and with a 90° twist between the opposing substrates, have been widely adopted as active matrix liquid crystal displays (LCDs). However, there has been a problem that the TN mode liquid crystal display devices give poor viewing angle characteristics, and various studies have been performed in order to improve the viewing angle characteristics.

As one alternative display design, an MVA (Multi-domain Vertical Alignment) mode has been developed, in which a liquid crystal material having a negative dielectric anisotropy is aligned in the vertical direction, and protrusions provided on or over the substrate surface and slits of electrode regulate the tilting directions of liquid crystal molecules during application of a voltage. This has been highly successful in improving viewing angle characteristics {see for example Japanese Patent No. 2947350 (Claims)}.

An MVA-mode liquid crystal panel is explained using FIG. 1A, FIG. 1B, and FIG. 2 as an example. FIG. 1A and FIG. 1B are schematic perspective diagrams showing the alignment of liquid crystal molecules in the liquid crystal panel of an MVA-mode liquid crystal display device; FIG. 2 is a schematic plane view showing the alignment directions of liquid crystal molecules in the liquid crystal panel of an MVA-mode liquid crystal display device.

In the liquid crystal panel of this MVA-mode liquid crystal display device, liquid crystal molecules 1 between two glass substrates, and having a negative dielectric anisotropy, are aligned vertically when no voltage is applied, as shown in FIG. 1A. Pixel electrodes connected to TFTs (Thin Film Transistors, not shown) are formed on one of the glass substrates 2, and a counter electrode is formed on the other glass substrate 3. Uneven portions (protrusions) 4 are formed in alternation on the pixel electrodes and on the counter electrode.

When a TFT is in the off state, that is, when no voltage is applied, the liquid crystal molecules are aligned in the direction vertical to the substrate interfaces, as shown in FIG. 1A. When the TFT is in the on state, that is, when a voltage is applied, the effect of the electric field causes the liquid crystal molecules to be tilted toward the horizontal direction, wherein the tilting directions of liquid crystal molecules 1 are regulated by the uneven portion structure. As a result the liquid crystal molecules are aligned in a plurality of directions within a single pixel, as indicated in FIG. 1B. For example, when the uneven portions 4 are formed as shown in FIG. 2, liquid crystal molecules 1 are aligned in each of the directions A, B, C and D. Thus in an MVA-mode liquid crystal display device, liquid crystal molecules are aligned in a plurality of directions when TFT's are in the on state, so that satisfactory viewing angle characteristics are obtained.

In the above MVA mode, the tilting directions of the liquid crystal molecules are not regulated by alignment control films. Hence there is no need for an alignment treatment process, of which rubbing is representative, which is necessary in nearly all parallel alignment mode devices, of which the TN mode devices are typical. Consequently the problem of electrostatic charge and debris due to rubbing can be eliminated from the processes, and there is no longer a need for a cleaning process after the alignment treatment. Moreover, there are no problems of display irregularities, etc. caused by unevenness of pretilt angles arising from the alignment, and so such advantages as simplified processes, improved production yields, and reduced costs are also obtained.

An object of the present invention is to further develop the above-described technology, and further enhance the reliability of liquid crystal display devices, while reducing or eliminating a phenomenon that horizontally-aligned domains that are called white lines remain in the vertically-aligned regions. Further objects and advantages of the present invention will become clear from the following explanation.

### SUMMARY OF THE INVENTION

According to one aspect of the present invention, a method of manufacture of a liquid crystal display device is provided, wherein a liquid crystal composition, comprising a liquid crystal and a polymerizable compound that is polymerizable by means of light, heat, or a combination thereof, is placed in the gap between two parallel substrates with a pair of electrodes formed thereon, and the polymerizable compound is polymerized, forming a liquid crystal layer and a resin film, and wherein the polymerizable compound comprises a monofunctional polymerizable compound, the dipole moment of which is 4 debyes or lower.

By means of this aspect of the present invention, a liquid crystal display panel with high reliability, with little or no tendency to exhibit white lines, and of excellent quality, can be manufactured.

It is preferable that the polymerizable compound comprises a polyfunctional polymerizable compound; that the liquid crystal molecules have a negative dielectric anisotropy, and that, when the dipole moment vector of the monofunctional polymerizable compound is resolved into components in the direction of the main chain and in a direction normal to the main chain, the component in the main chain direction is greater than the component in the normal direction, or, that the liquid crystal molecules have a positive dielectric anisotropy, and that, when the dipole moment vector of the monofunctional polymerizable compound is resolved into components in the direction of the main chain and in a direction normal to the main chain, the component in the main chain direction is smaller than the component in the normal direction; that the dipole moment of the polyfunctional polymerizable compound is 5 debyes or less; and that the liquid crystal composition is placed by a dropping injection method.

In another aspect of the present invention, a liquid crystal display device manufactured by the above-described manufacturing method is provided. By means of this aspect, a liquid crystal display device with high reliability, with little or no tendency to exhibit white lines, and of excellent quality, can be obtained.

In this aspect it is preferable that the liquid crystal molecules have a negative dielectric anisotropy, are aligned substantially vertically when no voltage is applied, and have the property of being tilted, when a voltage is applied, with the directions regulated by protrusions formed on or over the substrate or by slits of electrodes; and, it is preferable that there be no printed alignment control film.

By means of the present invention, a liquid crystal display device can be realized having high reliability, with little or no tendency to exhibit white lines, and of excellent quality.

### BRIEF DESCRIPTION OF THE DRAWINGS

FIG. 1A is a schematic perspective view showing the alignment of liquid crystal molecules in an MVA-mode liquid crystal panel;

FIG. 1B is a schematic perspective view showing the alignment of liquid crystal molecules in an MVA-mode liquid crystal panel;

FIG. 2 is a schematic plane view showing the alignment directions of liquid crystal molecules in the liquid crystal panel of an MVA-mode liquid crystal display device;

FIG. 3A is a schematic diagram showing a state in which a liquid crystal composition, comprising liquid crystal molecules and a polymerizable compound, is held between substrates;

FIG. 3B is a schematic diagram showing a liquid crystal layer and resin film after ultraviolet ray irradiation;

FIG. 4A is a schematic diagram showing a state in which a liquid crystal composition, comprising liquid crystal molecules and a polymerizable compound, is held between substrates;

FIG. 4B is a schematic diagram showing a liquid crystal layer and resin film after ultraviolet ray irradiation;

FIG. 5A is a photo of a pixel screen of a liquid crystal display panel, showing a state of white line occurrence;

FIG. 5B is a photo of a pixel screen of a liquid crystal display panel, showing a state of white line occurrence; and,

FIG. 6 is a schematic diagram showing cases in which a monofunctional polymerizable compound assumes structures of standing up from, and lying down on, the resin film surface.

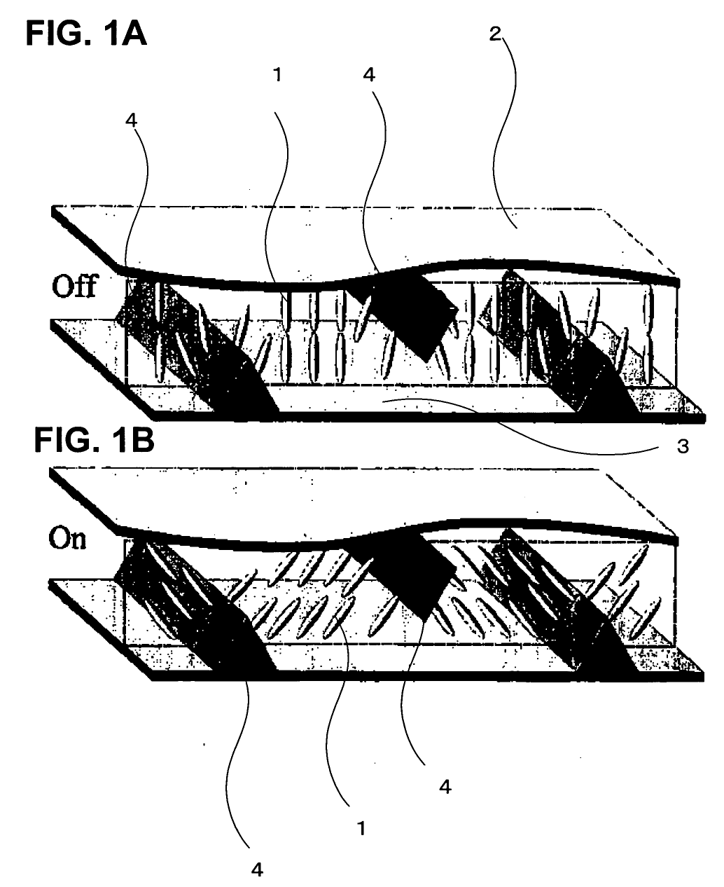

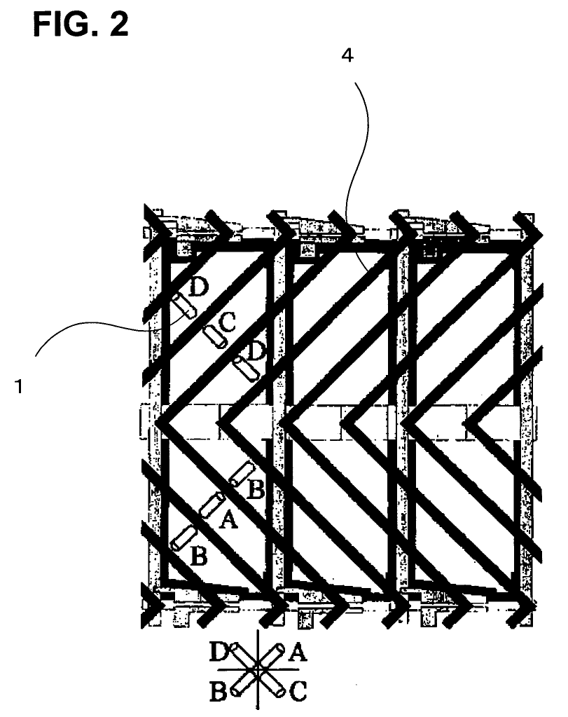

### DESCRIPTION OF THE PREFERRED EMBODIMENTS

Below, embodiments of the present invention are explained using drawings, tables, and examples. These drawings, tables, and examples, as well as the explanations themselves, merely illustrate the present invention, and do not limit the scope of the present invention. Of course other aspects which do not deviate from the gist of the present invention also fall within the scope of the present invention.

In a method of manufacture of a liquid crystal display device of the present invention, a liquid crystal composition, comprising a liquid crystal and a polymerizable compound which can be polymerized using light, heat, or a combination thereof, is placed in the gap between two parallel substrates on which are formed a pair of electrodes; then the polymerizable compound is polymerized, and a resin film is formed in contact with a liquid crystal layer. The desired alignment state is obtained only after the treatment with light, heat, or a combination thereof (after the reaction), which differs completely from methods in which a material which easily undergoes physical adsorption is merely added to the liquid crystals to control the alignment {as for example in Japanese Patent Laid-open No. 11-95221 (Claims)}.

This polymerizable compound has a molecular structure capable of regulating the director directions of the liquid crystal molecules when the resin film is formed, as well as a polymerizable functional group capable of polymerization caused by light, heat, or a combination thereof. Alkyl chains are typical examples of the molecular structure capable of regulating the director directions. The polymerizable functional group includes a group having an optical functionality such as an acrylate group, methacrylate group, vinyl group, allyl group, and unsaturated double.

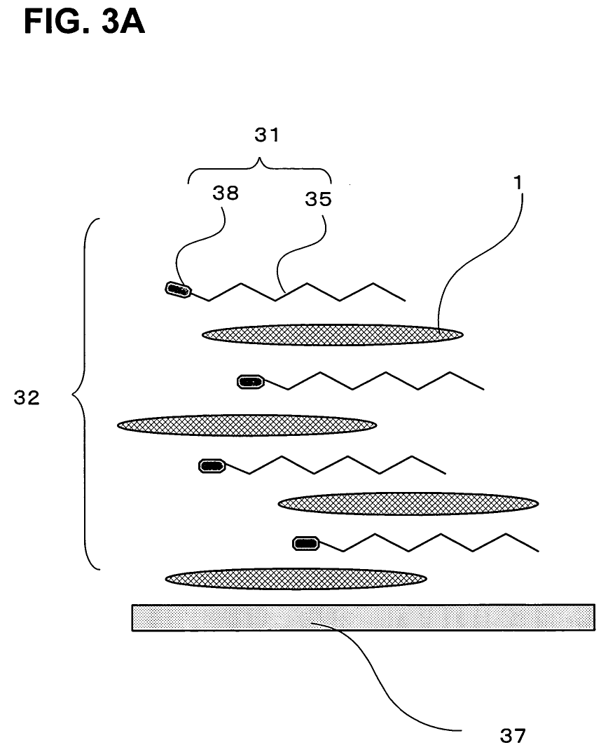

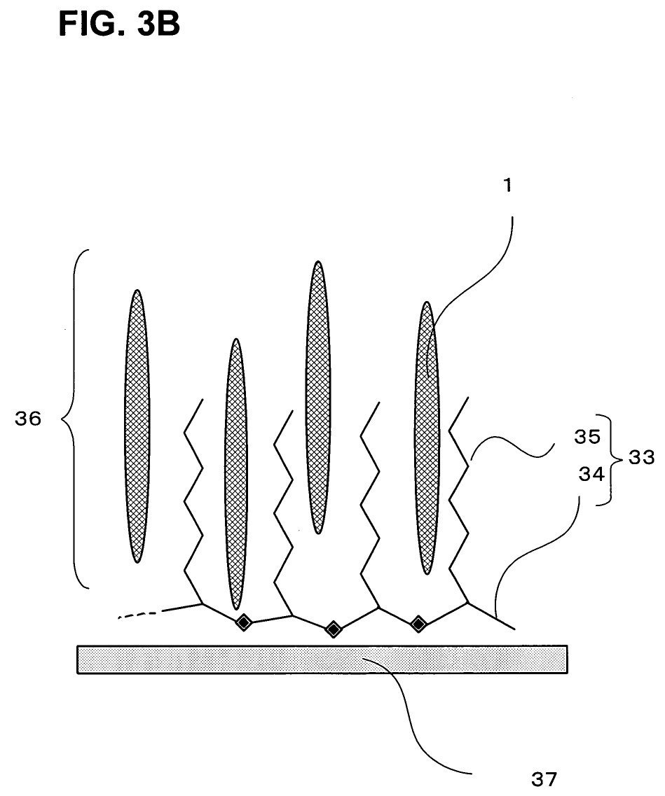

FIG. 3A and FIG. 3B illustrate the basic principle of the present invention. A liquid crystal composition 32, comprising liquid crystal molecules 1 and a polymerizable compound 31, comprising a polymerizable functional group 38 and a molecular structure part 35 capable of regulating the director directions, is held between substrates (FIG. 3A), and the polymerizable compound is then caused to undergo polymerization through for example irradiation with ultraviolet rays, to form a resin film 33 of desired thickness in contact with a liquid crystal layer 36, as shown in FIG. 3B. As the structure of the resin film 33, for example, a structure is assumed in which main polymer chains 34 adhere to a substrate 37, and molecular structural portions 35 which regulate the director directions of the liquid crystal molecules stand up so as to cause the liquid crystal molecules to be vertically aligned.

This structure differs from that of the prior art called polymer dispersed liquid crystals (PDLC), in that polymers are not formed spanning the entirety of the liquid crystal layer, but the alignment is controlled by a thin-film resin film formed in contact with the liquid crystal layer like an alignment control film.

In a case in which the resin film is formed only from a monofunctional polymerizable compound or compounds (compounds having one polymerizable functional group in one molecule), the main chains of the polymer have a linear structure, as shown in FIG. 3B, and the polymer accumulates and becomes entangled to form the resin film.

Even when adopting a structure such as this, it may be sometimes difficult to simultaneously satisfy the requirements, in the process of formation of the resin film, of adequately regulating the directions of the liquid crystal molecule director to realize high reliability, and of preventing the occurrence of white lines.

It has been found that by appropriately choosing the dipole moment of the polymerizable compound, this problem can be resolved. That is, regarding the molecular structure of the polymerizable compound, the direction and magnitude of the dipole moment plays an important role, and it is possible to manufacture a liquid crystal display device having a liquid crystal display panel with high reliability and in which the occurrence of white lines is suppressed, by selecting an appropriate molecular structure.

A liquid crystal display device of the present invention can be manufactured by a method of manufacture of a liquid crystal display device in which a liquid crystal composition, comprising a liquid crystal and a polymerizable compound which can be polymerized by light, heat, or a combination thereof, is placed in the gap between two parallel substrates on which are formed a pair of electrodes, after which the polymerizable compound is polymerized to form a liquid crystal layer and a resin film.

In the polymerization of the polymerizable compound, light, heat, or a combination thereof is used; the order may be chosen arbitrarily, or a plurality of combinations may be used. As the light, ultraviolet (UV) light is preferable.

As the polymerizable compound of the present invention, any known compound may be used which is not contrary to the gist of the present invention. In general, compounds selected from among monomers and oligomers are used. For example, compounds are enumerated that have a polymerizable functional group such as an acrylate group and methacrylate group of acrylate esters and methacrylate esters, for example, as well as an epoxy group, vinyl group, and allyl group.

In the present invention, the use of either a monofunctional polymerizable compound or of a polyfunctional polymerizable compound (a compound having two or more polymerizable functional groups in a single molecule) is possible; but when a resin film is formed, it is preferable that a monofunctional polymerizable compound be used in order to effectively exhibit the function to regulate the directions of the liquid crystal molecule director. The polymerizable compounds of the present invention can comprise so-called monomers and oligomers.

In the present invention, it is important that the dipole moment of the monofunctional polymerizable compound be small. It has been found that if the dipole moment is large, the reliability of the liquid crystal display device is diminished, and in addition white lines tend to appear.

It is thought that the reliability of the liquid crystal display device is affected by ionic impurities in the liquid crystal composition; that the polymerizable compound attracts ionic impurities when the dipole moment is large; and that the reliability of the liquid crystal display device is reduced as a result of this.

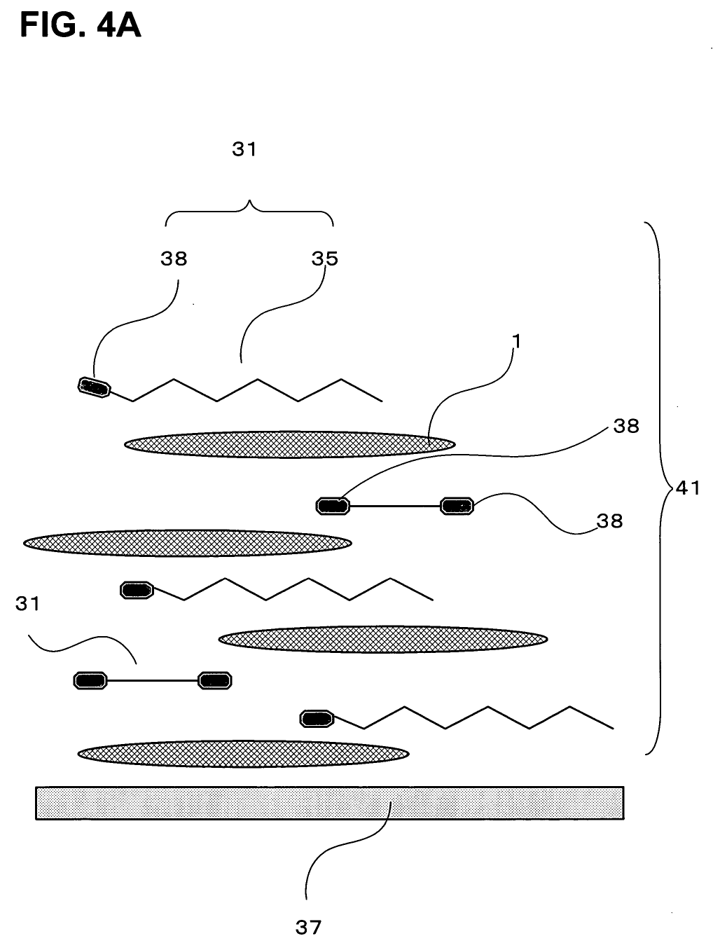

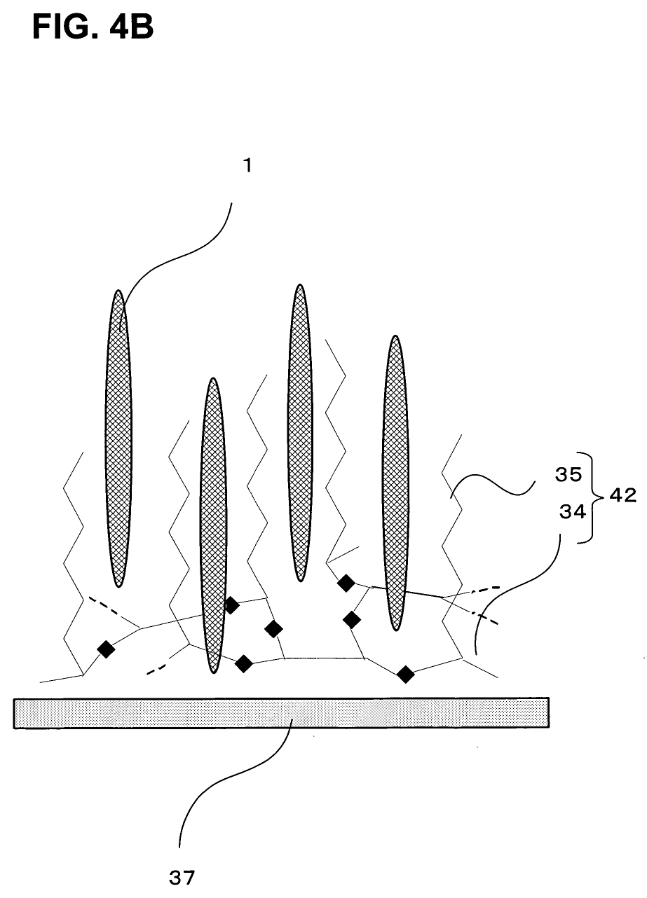

The tendency of white lines to occur when the dipole moment becomes large is thought to be attributed to reduction of the function to regulate the directions of the liquid crystal molecule director. In schematic terms, in FIG. 3A and FIG. 3B and in the subsequently described FIG. 4A and FIG. 4B, this is inferred to occur because, as the dipole moment increases the molecular structure portions 35 which regulate the directions of the liquid crystal molecule director can no longer easily assume a structure standing upward, so as to cause liquid crystal molecules to be aligned vertically. The dipole moment of the monofunctional polymerizable compound is important because it is primarily the monofunctional polymerizable compound which has the molecular structural portions regulating the directions of the liquid crystal molecule director.

As a specific value for the dipole moment, it is important that the dipole moment be 4 debyes or lower. If the dipole moment exceeds 4 debyes, the reliability of the liquid crystal display device is diminished, and white lines tend to occur.

This dipole moment is a value calculated in molecular simulations. When there exist a plurality of monofunctional polymerizable compounds, a weighted composite value of the dipole moments of each is used.

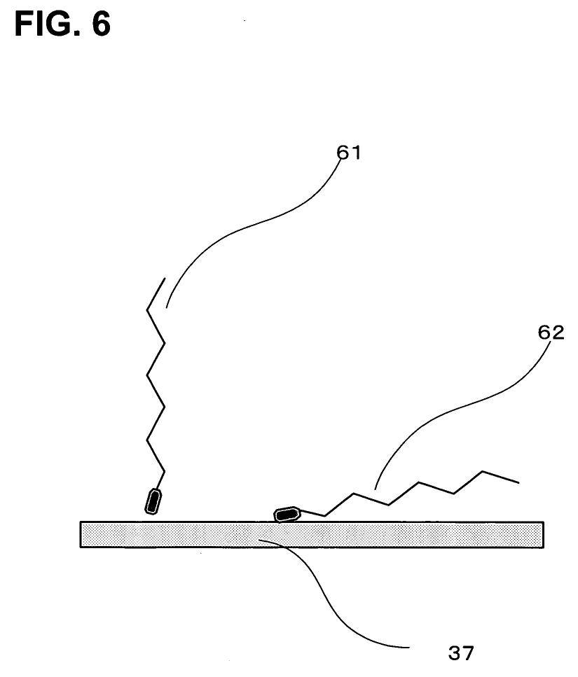

The dipole moment of a monofunctional polymerizable compound is a vector quantity which can be resolved into components in the direction of the main chain and in a direction normal to this. From this perspective, when liquid crystal molecules have a negative dielectric anisotropy, it is preferable that the component in the main chain direction be greater than the component in the normal direction. As indicated schematically in FIG. 6, this is inferred to occur because, if the component in the main chain direction is greater than the component in the normal direction, then the monofunctional polymerizable compound 61 can easily stand up from the resin film surface, and so as the polymerization advances in this state, a structure in which molecular structure portions regulating the director directions stand up from the resin film surface can be realized more easily; conversely, if the component in the main chain direction is smaller than the normal direction component, then the monofunctional polymerizable compound 62 tends to lie on the resin film surface, and if the polymerization advances in this state, then the molecular structural portions regulating the director directions tend to lie on the resin film surface.

Hence this effect is opposite when the liquid crystal molecules have a positive dielectric anisotropy, in which case it is preferable that the component in the main chain direction be smaller than the component in normal direction.

It is preferable that a liquid crystal composition of the present invention comprise, together with a monofunctional polymerizable compound, a polyfunctional polymerizable compound. This is explained referring to FIG. 4A and FIG. 4B.

FIG. 4A and FIG. 4B illustrate the basic principle of the present invention in a case in which polymerizable compounds are used having not only one functional group, but two or more functional groups as well. After a liquid crystal composition 41 comprising liquid crystal molecules 1 and two types of polymerizable compounds 31 is held between substrates (FIG. 4A), the polymerizable compounds are polymerized by for example irradiation with ultraviolet rays, to form a resin film 42 of the desired thickness in contact with the liquid crystal layer, as shown in FIG. 4B. In this case, by means of the polyfunctional polymerizable compound, polymers are formed in a three-dimensional network, as shown in FIG. 4B. This results in a stronger and more reliable resin film than in cases where only a monofunctional polymerizable compound is used.

Because the polyfunctional polymerizable compound is normally a minor component (for example, 10 wt. %), the dipole moment does not have so great an effect. Nevertheless, a very large value is not desirable. As the result of studies, it was found that a value of 5 debyes or less is preferable.

When using both a monofunctional polymerizable compound and a polyfunctional polymerizable compound, no limits in particular are imposed on the composition ratios of the monofunctional polymerizable compound and the polyfunctional polymerizable compound; but it is preferable that the composition ratio be determined through experiment or by other means, taking into consideration the extent of regulation of the liquid crystal molecule director directions actually required and the stability of adhesion of the resin film to the object for adhesion, and similar.

Thus by means of the present invention, a liquid crystal display device with high reliability can be realized. Further, a liquid crystal display device with superior quality can be obtained in which reduction in contrast due to white lines is alleviated or eliminated.

It is preferable that in such a liquid crystal display device, the liquid crystal molecules having a negative dielectric anisotropy, are substantially vertically aligned when no voltage is applied, and have a property of being tilted while regulating the directions through protrusions formed on or over the substrate and slits of electrodes when a voltage is applied, because they provide the simultaneous realization of excellent viewing angle characteristics and the various advantages described above, in the MVA mode.

Because the resin film adequately achieves regulation of the directions of the liquid crystal molecule director, there is no longer a need to provide alignment control films in the liquid crystal display device of the present invention. Of course alignment control films may also be provided.

Elimination of the printing process of alignment control films enables considerable cost reduction. Liquid crystal display devices can easily be manufactured using an ultra-large motherglass, which cannot be accommodated by the conventional alignment control film printing equipment, without being affected by the glass size. Moreover, liquid crystal display devices using substrates on which printing is difficult, such as substrates with substantial unevenness or substrates with curved surfaces, can also be realized.

Use of a dropping injection method rather than a vacuum injection method to inject the liquid crystal composition contributes to simplifying of the manufacturing processes and reducing of costs. Also, the range of liquid crystal material selection is greater compared with vacuum injection processes, thus contributing to improving vertical alignment properties. In this case, when alignment control films are used, drop spots may occur; this can be prevented by opting not to use alignment control films.

### EXAMPLES

Next, examples of the present invention are described in detail. The following methods were used to evaluate properties.

Dipole Moment

The WinMOPACC software for the molecular orbital calculation, produced by Fujitsu Ltd., was used to calculate the molecular dipole moments.

Reliability

Using VHR-1 by Toyo Technica Inc., with the initial applied voltage set to 5 V, the voltage after a holding time of 1667 ms expressed as a fraction of the initial voltage was determined as the voltage holding ratio.

### Example 1

A monofunctional monomer having an alkyl chain with from 6 to 18 CH₂ groups and with an acrylate group, a diacrylate bifunctional monomer having a ring structure, and a polymerization initiator were dissolved in a liquid crystal A produced by Merck & Co. and having a negative dielectric anisotropy to obtain a liquid crystal composition (the weight ratio of monofunctional monomer to bifunctional monomer=10:1). 15-type liquid crystal display panels were prepared by using cells having a thickness of 4.25 μm. Alignment control films were not used. As the monofunctional monomer, each of the five types shown in Table 1 was used.

Upon observing the alignment state of the liquid crystal display panels immediately after fabrication, nonuniform alignment was observed wherein horizontal and vertical alignments were present together.

Thereafter, the liquid crystal display panels were subjected to annealing for 30 minutes at 90° C., and after cooling, were irradiated to 9000 mJ with unpolarized ultraviolet rays, comprising wavelengths between 300 and 400 nm. Upon observing the alignment, it was found that vertical alignment was obtained over the entire areas of the liquid crystal display panels.

Table 1 shows the relationship between the dipole moment magnitudes of the monofunctional monomers and the reliability. When the dipole moment was greater than 4 debyes, the reliability was poor; when using monofunctional monomers with a dipole moment equal to 4 debyes or lower, a liquid crystal display panel with high reliability was obtained. At this time, the dipole moment of the difunctional monomer was 2 debyes.

TABLE 1
Relationship between the magnitudes of dipole moment
of monofunctional monomers and the reliability

| Magnitude of dipole moment | Reliability |
|---|---|
| 0.86 debye | 97.5% |
| 1.71 debye | 97.1% |
| 3.54 debye | 95.8% |
| 4.37 debye | 86.5% |
| 5.01 debye | 64.8% |

### Example 2

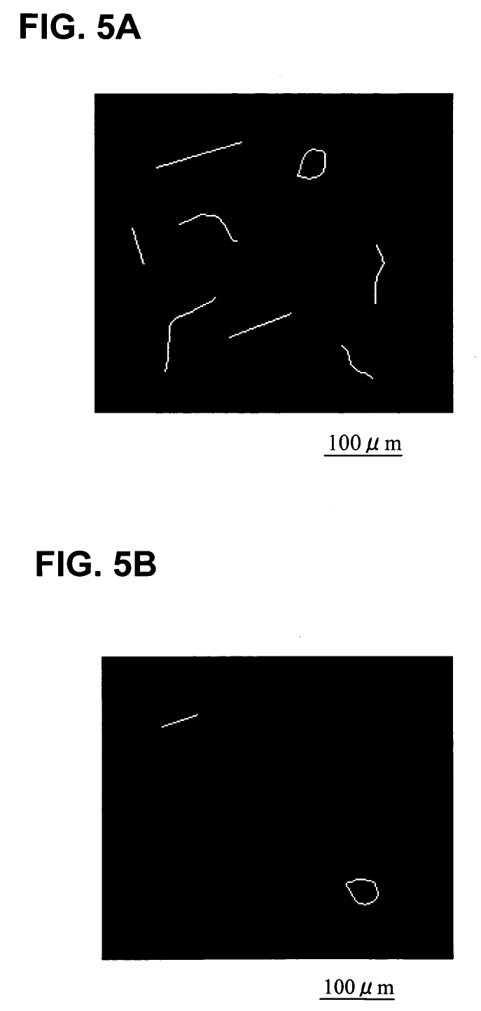

In experiments similar to that of EXAMPLE 1, the occurrence of white lines was investigated for a case in which, when the dipole moment vector of a monofunctional monomer was resolved into components in the directions of and normal to the main chain, the main chain direction component was larger than the normal direction component, and for a case in which, when the dipole moment vector of a monofunctional monomer was resolved into components in the directions of and normal to the main chain, the main chain direction component was smaller than the normal direction component. FIG. 5A and FIG. 5B show the occurrence of white lines due to differences in the directions of the dipole moments of monofunctional monomers in the fabricated liquid crystal display panels. FIG. 5A shows a pixel screen of a liquid crystal display panel where the main chain direction component of the dipole moment is approximately ⅕ of the normal direction component, and FIG. 5B shows a pixel screen where the main chain direction component of the dipole moment is approximately 5 times the normal direction component. A length equal to 100 μm is shown below both FIG. 5A and FIG. 5B.

FIG. 5A shows the white line occurrence when the main chain direction component of the dipole moment is smaller than the normal direction component; FIG. 5B shows the white line occurrence when the main chain direction component is larger than the normal direction component. As shown in FIG. 5B, when the main chain direction component was larger than the normal direction component, it was possible to fabricate a liquid crystal display panel with little occurrence of white lines. Such a difference was confirmed for all of the monofunctional monomers used in EXAMPLE 1.

### Example 3

In experiments similar to those of EXAMPLE 1, the dipole moment of the monofunctional monomer was fixed at approximately 3 debyes, that of a polyfunctional monomer was varied, and the relationship between the reliability and the magnitudes of dipole moment of polyfunctional monomers was investigated. Table 2 shows the relationship between reliability and the magnitudes of the polyfunctional monomer dipole moment. When the dipole moment magnitude was greater than 5 debyes, the reliability was low; when using polyfunctional monomers with a dipole moment at 5 debyes or below, liquid crystal panels with high reliability were obtained.

TABLE 2
Relationship between the magnitudes of dipole moment
of polyfunctional monomers and the reliability

| Magnitude of dipole moment | Reliability |
|---|---|
| 0.51 debye | 97.8% |
| 1.73 debye | 97.4% |
| 3.04 debye | 97.5% |
| 4.02 debye | 95.9% |
| 5.49 debye | 88.8% |

### Example 4

Experiments similar to those of EXAMPLE 1 were conducted. A liquid crystal display panel was fabricated using a dropping injection method. As a result, a liquid crystal panel with satisfactory reliability and vertical alignment could be obtained.

For comparison, upon adopting the dropping injection method for a liquid crystal display panel using alignment control films, when the dropping injection was performed in a state with the alignment control films attached, drop spots appeared. However, no such marks appeared when the method of the present invention was employed. Here, drop spots are circular marks appearing in the displaying at points where the liquid crystals have been dripped.

1. A method for manufacturing a liquid crystal display device, in which a liquid crystal composition, comprising a liquid crystal and a polymerizable compound capable of polymerization by means of light, heat, or a combination thereof, is placed in the gap between two parallel substrates on which are formed a pair of electrodes, and said polymerizable compound is polymerized to form a liquid crystal layer and a resin film, wherein:
said polymerizable compound comprises a monofunctional polymerizable compound; and,
the dipole moment of said monofunctional polymerizable compound is 4 debyes or lower.

2. The method for manufacturing a liquid crystal display device according to claim 1, wherein said polymerizable compound comprises a polyfunctional polymerizable compound.

3. The method for manufacturing a liquid crystal display device according to claim 2, wherein the dipole moment of said polyfunctional polymerizable compound is 5 debyes or lower.

4. The method for manufacturing a liquid crystal display device according to any one of claims 1 through 3, wherein:
said liquid crystal molecules have a negative dielectric anisotropy; and
when the vector of the dipole moment of said monofunctional polymerizable compound is resolved into components in the main chain direction and in a direction normal thereto, the component in the main chain direction is greater than the component in the normal direction.

5. The method for manufacturing a liquid crystal display device according to any one of claims 1 through 3, wherein said liquid crystal molecules have a positive dielectric anisotropy, and when the vector of the dipole moment of said monofunctional polymerizable compound is resolved into components in the main chain direction and in a direction normal thereto, the component in the main chain direction is smaller than the component in the normal direction.

6. The method for manufacturing a liquid crystal display device according to any one of claims 1 through 3, wherein the placement of said liquid crystal composition is performed by a dropping injection method.

7. A liquid crystal display device, manufactured by the manufacturing method according to any one of claims 1 through 3.

8. A liquid crystal display device, manufactured by the manufacturing method according to any one of claims 1 through 3, wherein said liquid crystal molecules have a negative dielectric anisotropy, and have the property of being substantially vertically aligned when no voltage is applied, and of being tilted with the directions regulated by protrusions formed on or over the substrate or by slits of the electrodes when a voltage is applied.

9. The liquid crystal display device according to claim 7 that do not have an alignment control film before the polymerization of the polymerizable compound.
